(19) United States
(12) Patent Application Publication
(10) Pub. No.: US 2017/0327341 A1
(43) Pub. Date: Nov. 16, 2017

(54) PRINTER

(71) Applicant: Funai Electric Co., Ltd., Osaka (JP)

(72) Inventor: Akira Hayashi, Kakogawa-shi (JP)

(73) Assignee: Funai Electric Co., Ltd., Osaka (JP)

(21) Appl. No.: 15/591,751

(22) Filed: May 10, 2017

(30) Foreign Application Priority Data
May 10, 2016 (JP) 2016-094630

(51) Int. Cl. B65H 85/00; B41J 11/00; B65H 3/56

(52) U.S. Cl. CPC B65H 85/00; B65H 3/56; B41J 11/0045; B65H 2801/06; B65H 2301/333

(57) ABSTRACT

A printer includes a sheet stopper that rotates between a regulating position where a sheet placed in the feeding tray is regulated and a passing position where the sheet placed in a feeding tray is passed through, and an inversion path introduction unit that rotates between a forward-feeding position and a reverse-feeding position of introducing the sheet. The inversion path introduction unit is disposed at the forward-feeding position when a sheet is conveyed in a sheet feeding direction. The inversion path introduction unit is disposed at the reverse-feeding position when a sheet is conveyed in a direction opposite to the sheet feeding direction and the inversion path introduction unit introduces the sheet into an inversion path. The sheet stopper changes the regulating position and the passing position in conjunction with rotation of the inversion path introduction unit.

### BACKGROUND

### Technical Field

The present invention generally relates to a printer.

### Related Art

Conventional printers perform duplex printing by inverting a sheet (for example, see patent literature 1).

Patent literature 1 discloses a printer that performs duplex printing by inverting a sheet (printer). With this printer, it is possible to perform duplex printing by, for example, feeding the sheet from a manual feeding unit. Moreover, with this printer, a duplex printing mechanism for performing duplex printing is disposed inside the device.

Patent Literature 1: Japanese Patent Application Publication No. 2015-013700

### SUMMARY

In the printer described in patent literature 1 above, because the manual feeding unit does not include a stopper mechanism that suppresses the sheet from being pushed in, a user may push in the sheet excessively in a situation of printing by feeding the sheet from the manual feeding unit. Because of this, a stopper mechanism may be provided. However, with a printer that performs duplex printing such as that described in patent literature 1 above, a duplex printing mechanism for performing duplex printing is disposed inside a device and, thus, securing space to dispose a stopper mechanism may be difficult. In this situation, the device may be increased in size to provide the stopper mechanism.

One or more embodiments of the present invention provides a printer that includes a stopper mechanism while suppressing a size increase of the printer.

A printer according to one or more embodiments of the present invention may comprise a feeding tray where a sheet is placed, a sheet stopper that rotates between a regulating position where the sheet placed in the feeding tray is regulated and a passing position of letting the sheet placed in the feeding tray pass through, and an inversion path introduction unit that can rotate between a forward-feeding state of sequentially feeding the sheet and a reverse-feeding position of reverse-feeding the sheet and introducing the sheet into an inversion path of the sheet, wherein the sheet stopper and the inversion path introduction unit are configured to be interlocked.

In a printer according to one or more embodiments of the present invention, the sheet stopper and the inversion path introduction unit are configured to be interlocked. By this, the sheet stopper that is a stopper mechanism, and the inversion path introduction unit that is a duplex-printing mechanism can share a drive mechanism; therefore, even if a stopper mechanism is provided, there is no need to provide a drive mechanism dedicated to the stopper mechanism. As a result, a space required to dispose both the stopper mechanism and the duplex-printing mechanism inside the printer can be decreased; therefore, the stopper mechanism can be provided while suppressing a size increase of the device.

In a printer according to one or more embodiments of the present invention, the sheet stopper has a stopper-side contact portion, the inversion path introduction unit has an introduction-unit-side contact portion, and the stopper-side contact portion and the introduction-unit-side contact portion contact each other at a contact area for interlocking. Thus, a component count can be further decreased compared to a situation where dedicated members are provided to interlock the sheet stopper and the inversion path introduction unit. As a result, the sheet stopper and the inversion path introduction unit can be rotated in conjunction with a simpler mechanism.

In a printer according to one or more embodiments of the present invention, when the sheet stopper is disposed at the regulating position, the introduction-unit-side contact portion supports the sheet stopper. Thus, the sheet stopper is supported by the introduction-unit-side contact portion of the inversion path introduction unit even in a situation where the sheet is pushed in by a user; therefore, the sheet stopper can be suppressed from moving due to a force of the sheet being pushed in. As a result, the sheet can be reliably stopped by the sheet stopper.

In a printer according to one or more embodiments of the present invention, when the sheet stopper is disposed at the regulating position, the contact area is positioned below a line passing through a rotation center of the sheet stopper and a rotation center of the inversion path introduction unit. Thus, a force in a direction of rotating from the regulating position to the passing position of the sheet stopper can be made to be received more readily by the inversion path introduction unit in a situation where the sheet stopper is supported from the side by the inversion path introduction unit. As a result, the force whereby the inversion path introduction unit supports the sheet stopper can be increased; therefore, the sheet can be more reliably stopped by the sheet stopper even in the situation where the sheet is pushed in by the user.

In a printer according to one or more embodiments of the present invention, when the sheet stopper is disposed at the passing position, the contact area is positioned above the line passing through the rotation center of the sheet stopper and the rotation center of the inversion path introduction unit. Thus, a force in a direction of rotating from the passing position to the regulating position of the sheet stopper can be imparted more readily from the inversion path introduction unit to the sheet stopper in a situation where the sheet stopper is rotated by the inversion path introduction unit. As a result, the sheet stopper can be readily rotated by the inversion path introduction unit.

In a printer according to one or more embodiments of the present invention, when the sheet stopper is disposed at the regulating position, a rotation shaft of the inversion path introduction unit is provided in a vicinity of a rotation shaft of the sheet stopper. Thus, stress can be readily concentrated in an area between the rotation shaft of the inversion path introduction unit and the contact portion (introduction-unit side contact portion); therefore, a force can be transferred more readily from the sheet stopper to the introduction-unit side contact portion of the inversion path introduction unit compared to a situation where the stress is dispersed over an entirety of the inversion path introduction unit. As a result, the introduction-unit side contact portion of the inversion path introduction unit can more readily receive the force of the sheet being pushed in acting on the sheet stopper; therefore, the force whereby the inversion path introduction unit supports the sheet stopper can be further increased. Therefore, the sheet can be even further reliably stopped by the sheet stopper even in the situation where the sheet is pushed in by the user.

A printer according to one or more embodiments of the present invention further includes a bearing that holds the rotation shaft of the inversion path introduction unit and the rotation shaft of the sheet stopper. Thus, the rotation shaft of the inversion path introduction unit and the rotation shaft of the sheet stopper can be held by the same bearing unit; therefore, the component count can be decreased even further. Moreover, by holding the rotation shaft of the inversion path introduction unit and the rotation shaft of the sheet stopper by the same bearing unit, the rotation shaft of the inversion path introduction unit can be readily provided in the vicinity of the rotation shaft of the sheet stopper.

In a printer according to one or more embodiments of the present invention, the sheet stopper and the inversion path introduction unit have the contact area, and the stopper-side contact portion is formed so as to be bent. Thus, the sheet stopper and the inversion path introduction unit can be rotated along the bent stopper-side contact portion of the sheet stopper; therefore, the sheet stopper and inversion path introduction unit can be smoothly rotated in conjunction.

In a printer according to one or more embodiments of the present invention, when the sheet stopper is disposed at the regulating position, the sheet stopper is configured to rotate toward a downstream side in a sheet feeding direction. By configuring in this manner, unlike a situation where in the regulating position the sheet stopper rotates toward an upstream side in the sheet feeding direction, the sheet stopper can be rotated from the regulating position to the passing position without being blocked by the sheet.

In a printer according to one or more embodiments of the present invention, when the sheet stopper is disposed at the regulating position, the sheet stopper has a center of gravity positioned on a downstream side, in the sheet feeding direction, of the rotation center of the sheet stopper. Thus, a weight of the sheet stopper itself can be utilized to readily rotate the sheet stopper toward the downstream side in the sheet feeding direction.

In a printer according to one or more embodiments of the present invention, when the sheet stopper is disposed at the regulating position, the sheet stopper is positioned on a downstream side, in the sheet feeding direction, of a sheet position when a maximum amount of the sheet is loaded in the feeding tray. By configuring in this manner, the sheet can be stopped by the sheet stopper by placing the sheet stopper in the regulating position even when the maximum amount of the sheet is loaded.

A printer according to one or more embodiments of the present invention further includes a sheet loading surface that contacts a lower end of the sheet placed in the feeding tray. When the sheet stopper is disposed at the passing position, the sheet stopper is disposed below the sheet loading surface. Thus, when the sheet stopper is disposed at the passing position, the sheet stopper can be suppressed from impeding conveyance of the sheet, which passes through the sheet loading surface.

In a printer according to one or more embodiments of the present invention, a rotation angle between the reverse-feeding position and the forward-feeding position of the inversion path introduction unit is less than a rotation angle between the regulating position and the passing position of the sheet stopper. Thus, the rotation angle of the inversion path introduction unit decreases; therefore, the inversion path introduction unit can be suppressed from rotating excessively (standing up).

In a printer according to one or more embodiments of the present invention, the rotation angle between the reverse-feeding position and the forward-feeding position of the inversion path introduction unit is half or less than the rotation angle between the regulating position and the passing position of the sheet stopper. Thus, the rotation angle of the inversion path introduction unit further decreases; therefore, the inversion path introduction unit can be further suppressed from rotating excessively (standing up).

In a printer according to one or more embodiments of the present invention, when the rotation angle between the reverse-feeding position and the forward-feeding position of the inversion path introduction unit is less than the rotation angle between the regulating position and the passing position of the sheet stopper, the rotation angle between the reverse-feeding position and the forward-feeding position of the inversion path introduction unit is one-third or less than the rotation angle between the regulating position and the passing position of the sheet stopper. Thus, the rotation angle of the inversion path introduction unit decreases even further; therefore, the inversion path introduction unit can be suppressed even further from rotating excessively (standing up).

A printer according to one or more embodiments of the present invention further includes a drive mechanism unit that rotates the inversion path introduction unit. The sheet stopper is rotated in accordance with the rotation of the inversion path introduction unit. Thus, in a situation where the inversion path introduction unit is larger than the sheet stopper, the sheet stopper, which is a small member, can be rotated in conjunction with the rotation of the inversion path introduction unit, which is a large member; therefore, the sheet stopper and the inversion path introduction unit can be readily rotated in conjunction.

In a printer according to one or more embodiments of the present invention, the drive mechanism unit includes a motor, a gear that is rotated by the motor, and a gear connecting portion that connects the gear and the inversion path introduction unit. Thus, a drive force generated by the motor can be transferred to the inversion path introduction unit via the gear and the gear connecting portion to rotate the inversion path introduction unit and the sheet stopper.

A printer according to one or more embodiments of the present invention includes the drive mechanism unit that includes the motor that generates the drive force and a feeding roller for feeding the sheet placed in the feeding tray. The motor of the drive mechanism unit rotates the feeding roller. Thus, the sheet stopper, the inversion path introduction unit, and the feeding roller can be moved by the same power source (the motor of the drive mechanism unit); therefore, the component count can be decreased compared to a situation where a power source for the feeding roller is provided separately.

A printer according to one or more embodiments of the present invention includes the drive mechanism unit that rotates the inversion path introduction unit and includes a solenoid that generates a drive force and a solenoid connecting portion that connects the solenoid and the inversion path introduction unit. Thus, the drive force generated by the solenoid can be transferred to the inversion path introduction unit via the solenoid connecting portion to rotate the inversion path introduction unit and the sheet stopper.

A printer according to one or more embodiments of the present invention includes a feeding tray, a sheet stopper, and an inversion path introduction unit. wherein in a situation where the sheet stopper enters a regulating position of stopping sheet placed in the feeding ray, in conjunction therewith, the inversion path introduction unit enters a reverse-feeding position of reverse-feeding the sheet and introducing the sheet into an inversion path of the sheet and in a situation where the sheet stopper enters a passing position of letting the sheet placed in the feeding tray pass through, in conjunction therewith, the inversion path introduction unit enters a forward-feeding position of sequentially sending the sheet.

In a printer according to one or more embodiments of the present invention, when the sheet stopper is disposed at the regulating position, in conjunction therewith, the inversion path introduction unit enters the reverse-feeding position of reverse-feeding the sheet and introducing the sheet into the inversion path of the sheet. When the sheet stopper is disposed at the passing position, in conjunction therewith, the inversion path introduction unit enters the forward-feeding position of sequentially sending the sheet. By this, according to one or more embodiments of the present invention, a stopper mechanism can be provided while suppressing a size increase of the device.

According to one or more embodiments of the present invention, a printer includes a sheet stopper that rotates between a regulating position where a sheet placed in the feeding tray is regulated and a passing position where the sheet placed in a feeding tray is passed through; and an inversion path introduction unit that rotates between a forward-feeding position and a reverse-feeding position of introducing the sheet. The inversion path introduction unit is disposed at the forward-feeding position when a sheet is conveyed in a sheet feeding direction. The inversion path introduction unit is disposed at the reverse-feeding position when a sheet is conveyed in a direction opposite to the sheet feeding direction and the inversion path introduction unit introduces the sheet into an inversion path. The sheet stopper changes the regulating position and the passing position in conjunction with rotation of the inversion path introduction unit.

According to one or more embodiments of the present invention, a printer includes a sheet stopper and an inversion path introduction unit interlocked with the sheet stopper. When the sheet stopper moves to a regulating position where a sheet placed in the feeding tray is regulated, the inversion path introduction unit moves to a reverse-feeding position. The inversion path introduction unit is disposed at the reverse-feeding position when a sheet is conveyed in a direction opposite to a sheet feeding direction and the inversion path introduction unit introduces the sheet into an inversion path. When the sheet stopper moves to a passing position where the sheet placed in the feeding tray is passed through, the inversion path introduction unit moves to a forward-feeding position. The inversion path introduction unit is disposed at the forward-feeding position when a sheet is conveyed in the sheet feeding direction.

One or more embodiments of the present invention can suppress a size increase of a printer that includes a stopper mechanism.

### BRIEF DESCRIPTION OF DRAWINGS

FIG. 1 is a perspective view illustrating a printer according to a first embodiment of the present invention.

FIG. 2 is a plan view illustrating the printer according to the first embodiment of the present invention.

FIG. 3 is an enlarged perspective view illustrating a vicinity of a sheet stopper and an inversion path introduction unit of the printer according to the first embodiment of the present invention.

FIG. 4 is another enlarged perspective view illustrating the vicinity of the sheet stopper and the inversion path introduction unit of the printer according to the first embodiment of the present invention.

FIG. 5 is a side view illustrating the printer of when the sheet stopper is disposed at a passing position and the inversion path introduction unit is disposed at a forward-feeding position according to the first embodiment of the present invention.

FIG. 6 is a side view illustrating the printer of when the sheet stopper is disposed at a regulating position and the inversion path introduction unit is disposed at a reverse-feeding position according to the first embodiment of the present invention.

FIGS. 7A-7D are diagrams showing a rotation operation of the sheet stopper and the inversion path introduction unit of the printer according to the first embodiment of the present invention.

FIG. 8 is a diagram for describing a sheet feeding path of the printer according to the first embodiment of the present invention.

FIG. 9 is a diagram for describing an inversion path of the printer according to the first embodiment of the present invention.

FIG. 10 is a plan view illustrating a printer according to a second embodiment of the present invention.

FIG. 11 is an enlarged perspective view illustrating a vicinity of a solenoid of the printer according to the second embodiment of the present invention.

FIG. 12 is an enlarged plan view illustrating the vicinity of the solenoid of the printer according to the second embodiment of the present invention.

FIG. 13 is a side view illustrating the printer of when the sheet stopper is disposed at the passing position and an inversion path introduction unit is disposed at the forward-feeding position according to the second embodiment of the present invention.

FIG. 14 is a side view illustrating the printer of when the sheet stopper is disposed at the regulating position and the inversion path introduction unit is disposed at the reverse-feeding position according to the second embodiment of the present invention.

### DETAILED DESCRIPTION

Embodiments of the present invention will be described in detail below with reference to the drawings. In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

(Configuration of Duplex Printing Device)

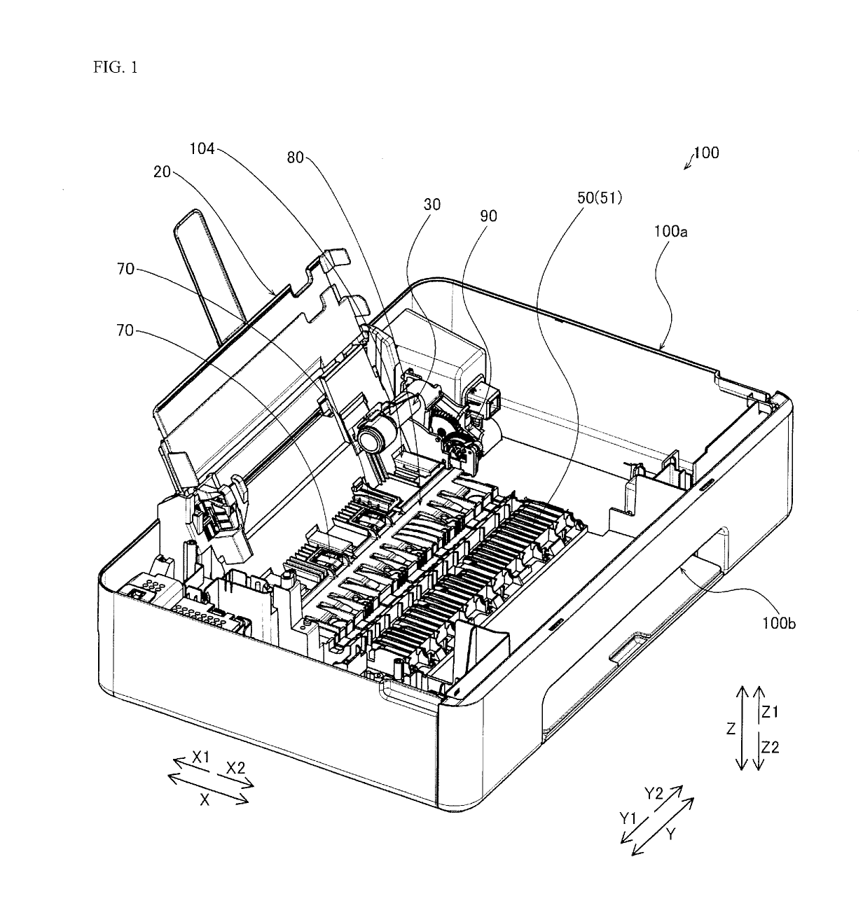

First, a configuration of a printer 100 according to a first embodiment of the present invention is described with reference to FIGS. 1 to 9.

As illustrated in FIGS. 1, 2, 8, and 9, the printer 100 according to the first embodiment of the present invention is an inkjet printer with duplex printing that prints an image on sheet 101 by discharging ink.

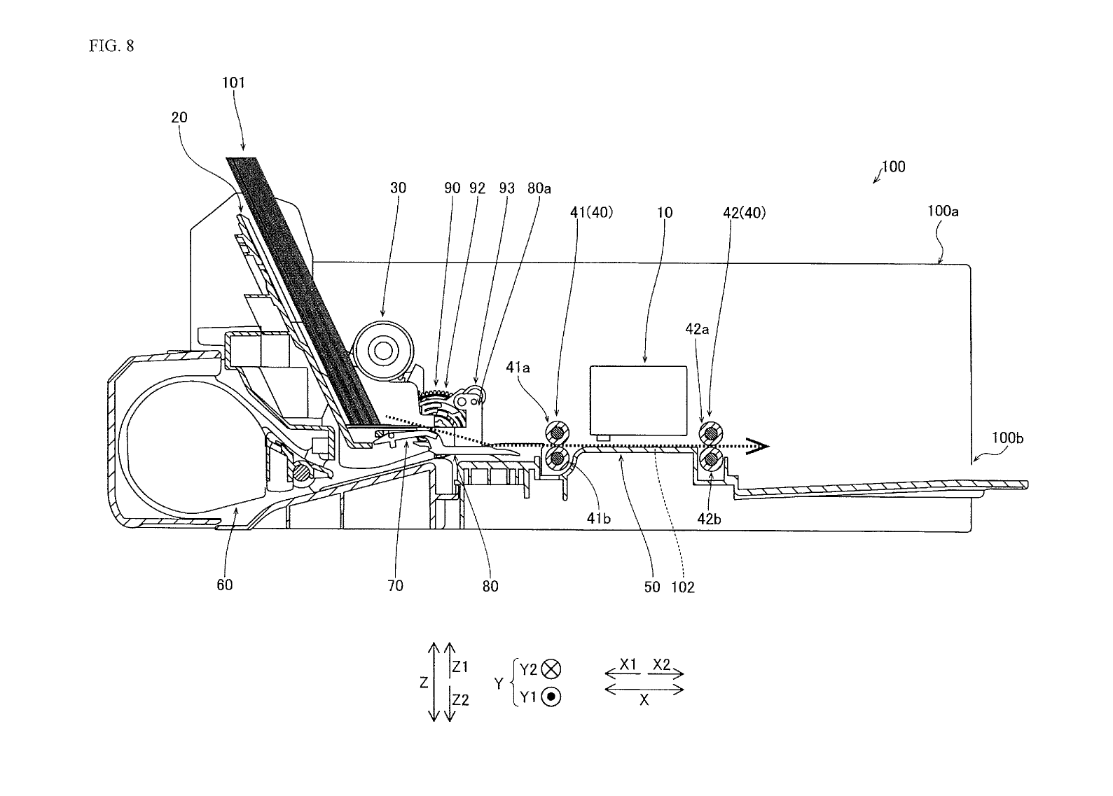

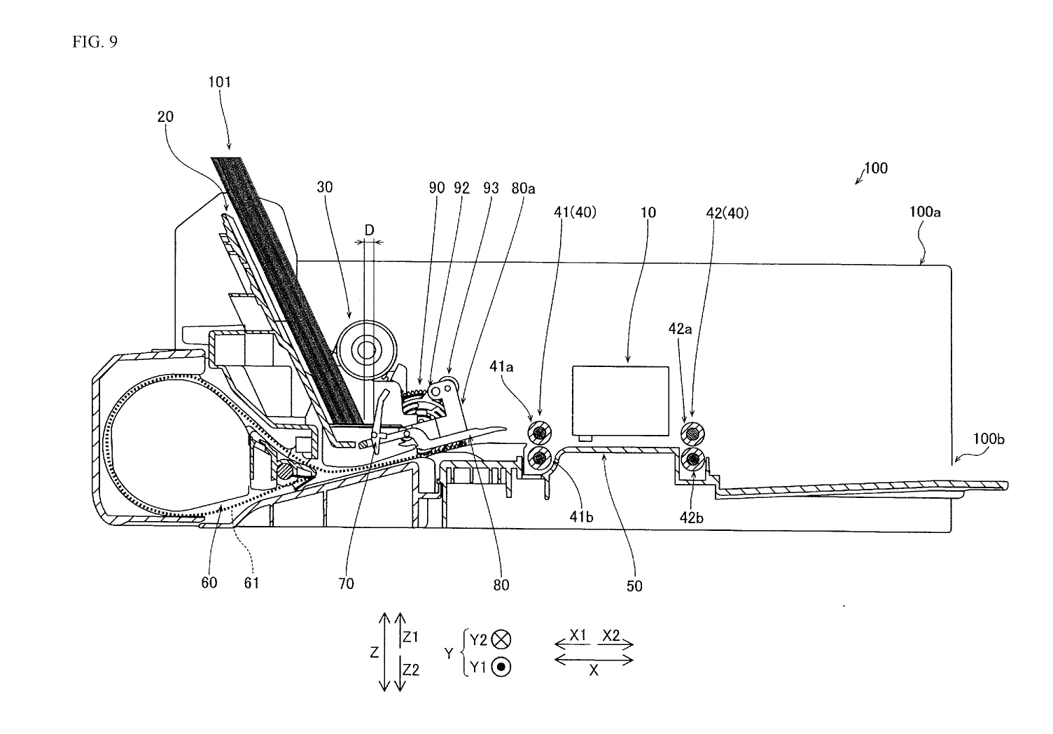

As illustrated in FIGS. 8 and 9, the printer 100 is includes a printhead 10. The printhead 10 discharges the ink onto the sheet 101. Moreover, the printhead 10 is configured so an ink cartridge (not illustrated) filled with the ink is detachable mounted thereto. Moreover, the printhead 10 is moved along a Y direction by a drive mechanism that is not illustrated.

In one or more embodiments of the present invention, the movement direction of the printhead 10 is defined as the Y direction, a sheet feeding direction orthogonal to the Y direction in a horizontal plane is defined as an X direction, and a direction orthogonal to the X direction and the Y direction is defined as a Z direction (vertical direction).

In the printer 100, the printhead 10 is configured to print the image on the sheet 101 by discharging the ink filled in the ink cartridge while moving in the Y direction.

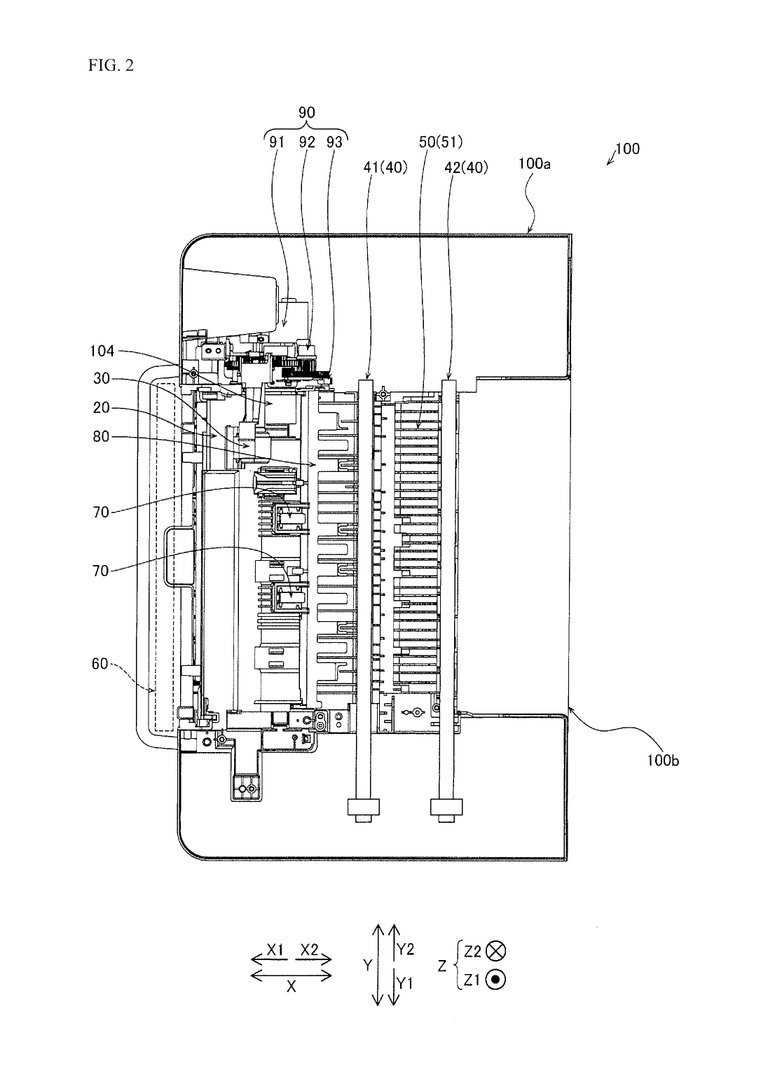

As illustrated in FIGS. 1 and 2, the printer 100 includes a feeding tray 20. The feeding tray 20 is configured so the sheet 101 before printing can be placed (loaded) therein in order to feed the sheet 101 into a housing 100a of the printer 100. The feeding tray 20 is formed at an incline relative to the horizontal plane (XY plane). The sheet 101 is placed by being stacked onto the feeding tray 20 in a state of being at an incline relative to the horizontal plane.

The printer 100 includes a feeding roller 30. The feeding roller 30 is configured to move (feed) the sheet 101 loaded in the feeding tray 20 toward the printhead 10 by being rotated by a drive mechanism unit 90 described below.

The printer 100 includes a conveyance roller 40. The conveyance roller 40 is configured to convey the sheet 101 in the housing 100a of the printer 100. As illustrated in FIGS. 8 and 9, the conveyance roller 40 includes an upstream-side conveyance roller 41 disposed on an upstream side (X1 side) of the printhead 10 and a downstream-side conveyance roller 42 disposed on a downstream side (X2 side) of the printhead 10.

The upstream-side conveyance roller 41 has a pair of conveyance rollers 41a and 41b. The pair of conveyance rollers 41a and 41b is disposed in a position of mutual opposition in the vertical direction (Z direction). The pair of conveyance rollers 41a and 41b is configured to interpose the sheet 101 between the pair of conveyance rollers 41a and 41b and convey the sheet 101 toward the printhead 10 on a downstream side by being rotated by a drive mechanism (not illustrated) that is different from the drive mechanism unit 90.

The downstream-side conveyance roller 42 includes a pair of conveyance rollers 42a and 42b. The pair of conveyance rollers 42a and 42b is disposed in a position of mutual opposition in the vertical direction. The pair of conveyance rollers 42a and 42b is configured to interpose the sheet 101 between the pair of conveyance rollers 42a and 42b and convey the sheet 101 toward a discharge port 100b on the downstream side by being rotated by a drive mechanism (not illustrated) that is different from the drive mechanism unit 90.

The printer 100 includes a platen unit 50. The platen unit 50 is disposed below the printhead 10 in a position opposing the printhead 10 in the vertical direction (Z direction). The platen unit 50 is configured to support from below the sheet 101 conveyed by the conveyance roller 40. The platen unit 50 includes a plurality of ribs 51 (see FIGS. 1 to 3) for supporting the sheet 101 from below (Z2 direction).

As illustrated in FIGS. 2, 8, and 9, the printer 100 includes an inversion path unit 60. The inversion path unit 60 is provided to invert a front and rear of the sheet 101 in a situation of performing duplex printing or face-down printing (printing where a surface opposite a printing surface is discharged as an upper surface). In the printer 100, the inversion path unit 60 is provided below (Z2 direction) a back-surface side (X1 side) of the feeding tray 20.

As illustrated in FIGS. 1 to 9, the printer 100 includes a sheet stopper 70. The sheet stopper 70 is a member that stops the sheet 101 to suppress the sheet 101 from being pushed in excessively into the housing 100a from the feeding tray 20. The sheet stopper 70 is provided on a sheet feeding path 102 (see FIG. 8) on a downstream side, in the sheet feeding direction, of the feeding tray 20. As illustrated in FIGS. 1 to 4, in the printer 100 of the first embodiment of the present invention, two sheet stoppers 70 are disposed lined up in the Y direction.

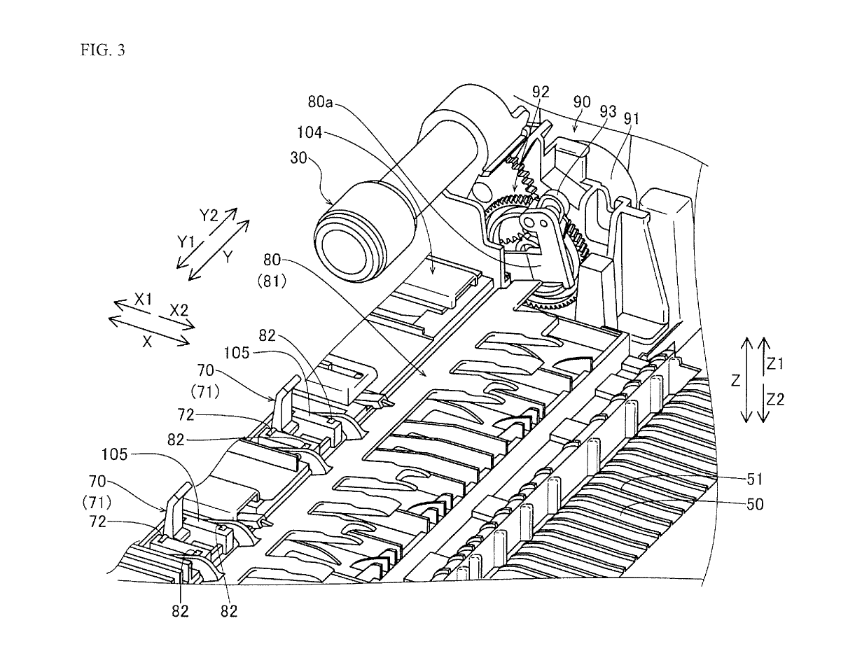

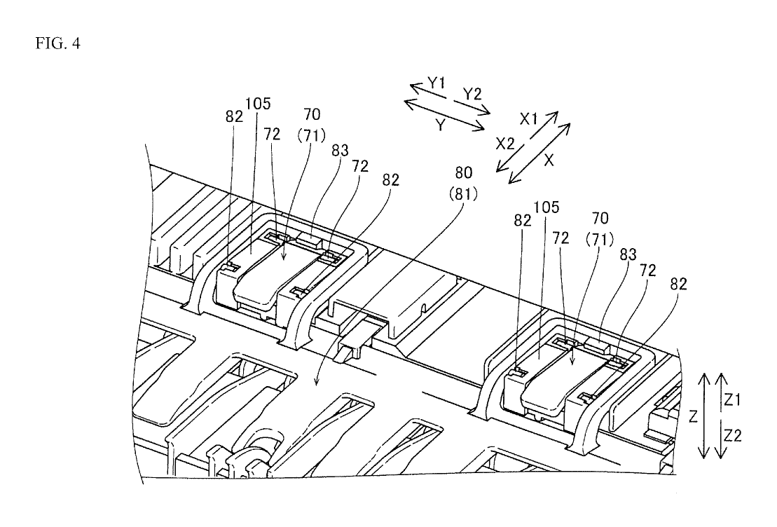

The sheet stopper 70 is configured to be able to rotate between a regulating position where the sheet 101 placed in the feeding tray 20 is regulated (for example, see FIGS. 3, 6, and 9) and a passing position where the sheet 101 placed in the feeding tray 20 is passed through (for example, see FIGS. 4, 5, and 8). When the sheet stopper 70 is disposed at the regulating position, the sheet stopper 70 is standing so as to protrude onto the sheet feeding path 102. When the sheet stopper 70 is disposed at the passing position, the sheet stopper 70 does not protrude onto the sheet feeding path 102 but is collapsed along the sheet feeding path 102.

The sheet stopper 70 includes a main body portion 71 and a rotation shaft 72. The main body portion 71 has a claw shape. The main body portion 71 having the claw shape extends in the sheet feeding direction when the sheet stopper 70 is disposed at the passing position and protrudes onto the sheet feeding path 102 when the sheet stopper 70 is disposed at the regulating position. The rotation shaft 72 is provided to rotate the main body portion 71 around an axis parallel to the Y direction. The rotation shaft 72 is formed so as to extend in the Y direction from both sides, in the Y direction, of the main body portion 71.

The printer 100 includes an inversion path introduction unit (gate member) 80. The inversion path introduction unit 80 is a member for introducing the sheet 101 into an inversion path 61 (see FIG. 9) that inverts the sheet 101 in order to perform duplex printing or face-down printing of the sheet 101. The inversion path introduction unit 80 is formed so as to extend in a width direction (Y direction) orthogonal to the sheet feeding direction from a vicinity of an end portion on one side, in the width direction, of the sheet feeding path 102 to a vicinity of an end portion on another side thereof.

The inversion path introduction unit 80 is configured to be able to rotate between a forward-feeding position of feeding the sheet 101 to the downstream side (X2 side) in the sheet feeding direction (for example, see FIGS. 4, 5, and 8) and a reverse-feeding position of reverse-feeding the sheet 101 to an opposite side (X1 side) of the downstream side in the sheet feeding direction and introducing the sheet 101 into the inversion path 61 (for example, see FIGS. 3, 6, and 9). In other words, the inversion path introduction unit 80 is disposed at the forward-feeding position when the sheet 101 is conveyed in the sheet feeding direction. The inversion path introduction unit 80 is disposed at the reverse-feeding position when the sheet 101 is conveyed in a direction opposite to the sheet feeding direction and the inversion path introduction unit 80 introduces the sheet into an inversion path. When the inversion path introduction unit 80 is disposed at the reverse-feeding position, the inversion path introduction unit 80 is slightly raised relative to the forward-feeding position so the sheet 101 is introduced into the inversion path 61 when the sheet 101 is conveyed in the direction opposite to the sheet feeding direction. When the inversion path introduction unit 80 is disposed at the forward-feeding position, the inversion path introduction unit 80 is collapsed relative to the reverse-feeding position so forward feeding of the sheet 101 is not impeded when the sheet 101 is conveyed in the sheet feeding direction.

As illustrated in FIGS. 3 to 7D, the inversion path introduction unit 80 includes a gate portion 81 and a rotation shaft 82. The gate portion 81 is formed so as to extend in the sheet feeding direction. The gate portion 81 is configured to guide and introduce the sheet 101 into the inversion path 61 by being raised in the reverse-feeding position. The gate portion 81 is configured to not impede sequential feeding of the sheet 101 by being collapsed in the forward-feeding position. The rotation shaft 82 is provided to rotate the inversion path introduction unit 80 around an axis parallel to the Y direction. The rotation shaft 82 is formed so as to extend in the Y direction.

As illustrated in FIGS. 1 and 2, the printer 100 includes a drive mechanism unit 90. The drive mechanism unit 90 is provided on a Y2 side of the inversion path introduction unit 80 and is configured to rotate the inversion path introduction unit 80.

As illustrated in FIGS. 2, 3, 5, and 6, the drive mechanism unit 90 includes a motor 91, a gear 92, and an arm portion 93. The motor 91 is configured to generate a drive force for rotating the inversion path introduction unit 80. The gear 92 is configured by a plurality of gears and is configured to be rotated by the drive force generated by the motor 91. The arm portion 93 is provided to the gear 92. Moreover, the arm portion 93 is configured to rotate in accordance with the rotation of the gear 92. Moreover, the arm portion 93 is configured to connect a sidewall portion 80a on the Y2 side of the inversion path introduction unit 80 and the gear 92. The arm portion 93 is an example of the “gear connecting portion” in one or more embodiments of the present invention.

(Interlocking Mechanism of Paper Stopper and Inversion Path Introduction Unit)

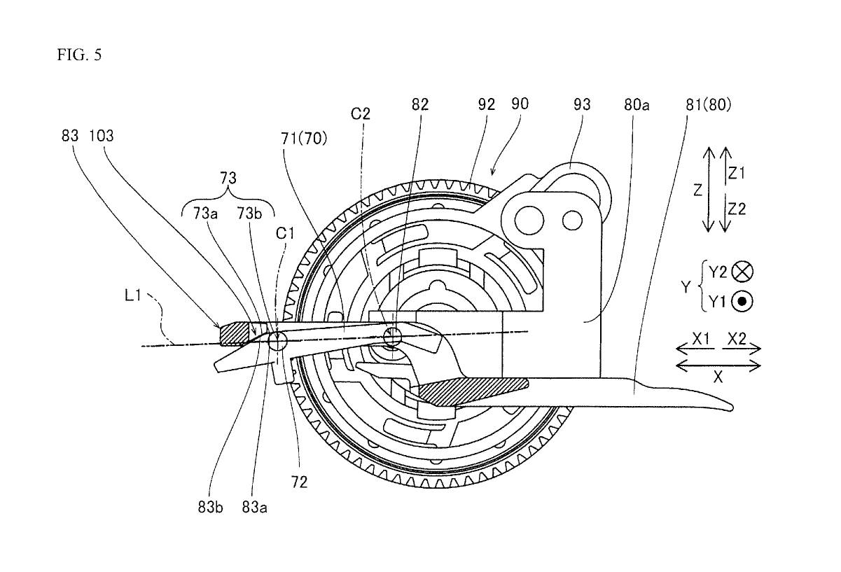

Here, in the first embodiment of the present invention, the sheet stopper 70 and the inversion path introduction unit 80 are configured to rotate in conjunction. Specifically, as illustrated in FIGS. 5 to 7D, the sheet stopper 70 and the inversion path introduction unit 80 are configured to contact each other at a contact area 103 for rotating in conjunction. At the contact area 103, a contact portion 73 of the sheet stopper 70 and a contact portion 83 of the inversion path introduction unit 80 contact each other. The contact portion 73 of the sheet stopper 70 is formed so as to be bent. The contact portion 73 is an example of the “stopper-side contact portion” in one or more embodiments of the present invention. Moreover, the contact portion 83 is an example of the “introduction-unit-side contact portion” in one or more embodiments of the present invention.

In the forward-feeding position, the contact portion 83 of the inversion path introduction unit 80 has a first contact part 83a extending in the vertical direction and a second contact part 83b extending diagonally downward toward an X1 direction from a lower end of the first contact part 83a. Moreover, the contact portion 73 of the sheet stopper 70 has a first contact part 73a that, in the passing position, makes surface contact with the second contact part 83b of the inversion path introduction unit 80 and, in the regulating position, makes surface contact with the first contact part 83a of the inversion path introduction unit 80. Moreover, the contact portion 73 of the sheet stopper 70 has a second contact part 73b that is bent relative to the first contact part 73a and, during rotation, contacts the first contact part 83a or the second contact part 83b of the inversion path introduction unit 80.

In the passing position the first contact part 73a of the sheet stopper 70 does not have to be making surface contact with the second contact part 83b of the inversion path introduction unit 80. For example, in the passing position, there may be a gap between the first contact part 73a of the sheet stopper 70 and the second contact part 83b of the inversion path introduction unit 80. In this situation, the first contact part 73a of the sheet stopper 70 makes surface contact with the second contact part 83b of the inversion path introduction unit 80 when the first contact part 73a moves from the passing position by an amount corresponding to the gap.

Furthermore, in the regulating position, the first contact part 73a of the sheet stopper 70 does not have to be making surface contact with the first contact part 83a of the inversion path introduction unit 80. For example, there may be a gap between the first contact part 73a of the sheet stopper 70 and the first contact part 83a of the inversion path introduction unit 80. In this situation, the first contact part 73a of the sheet stopper 70 makes surface contact with the first contact part 83a of the inversion path introduction unit 80 when the first contact part 83a moves from the regulating position by an amount corresponding to the gap.

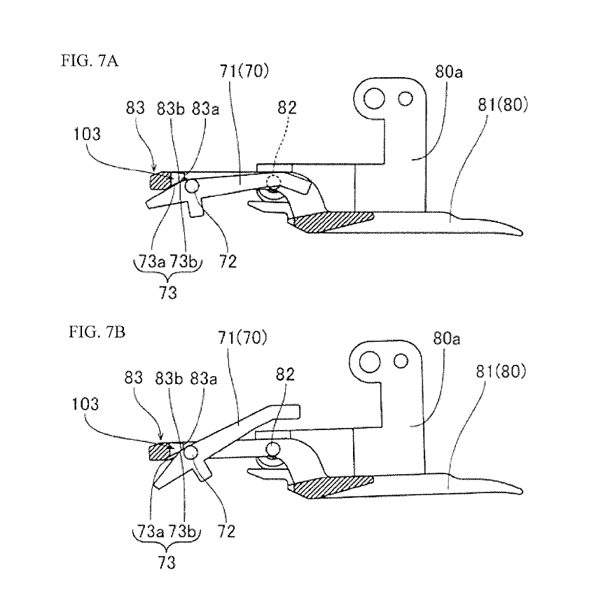

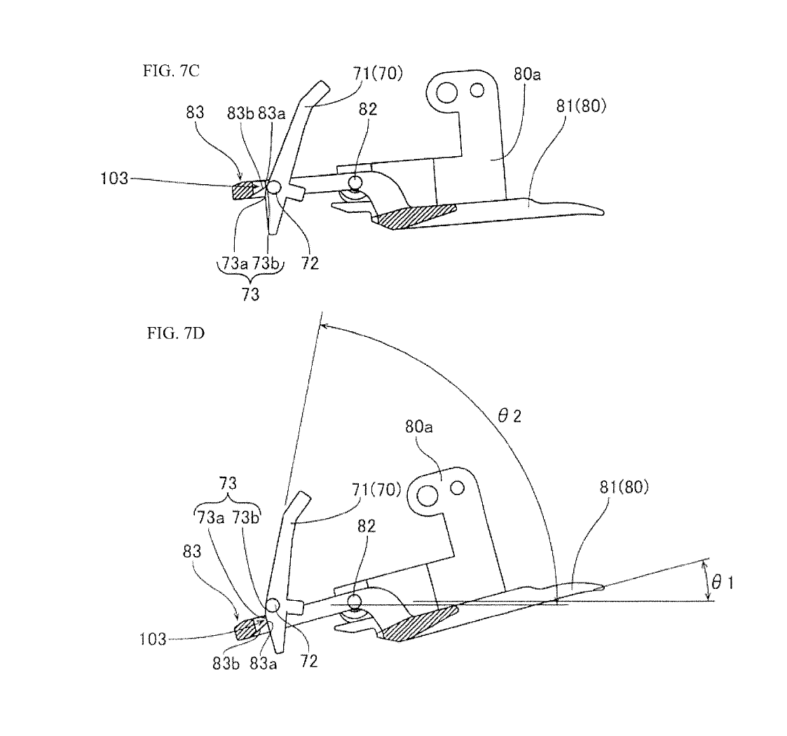

The rotation of the sheet stopper 70, which is in conjunction with the rotation of the inversion path introduction unit 80, is described with reference to in FIGS. 7A-7D. First, as illustrated in FIG. 7A, a state is entered into where the sheet stopper 70 is in the passing position and the inversion path introduction unit 80 is in the forward-feeding position. In this state, the contact area 103 is formed by the first contact part 73a of the sheet stopper 70 and the second contact part 83b of the inversion path introduction unit 80 making surface contact.

When, from this state, the inversion path introduction unit 80 is rotated toward the reverse-feeding position, the first contact part 73a of the sheet stopper 70 is pushed by the second contact part 83b of the inversion path introduction unit 80. As a result, the sheet stopper 70 begins to rotate toward the regulating position. Then, as illustrated in FIG. 7B, in conjunction with the rotation of the sheet stopper 70, the first contact part 73a of the contact portion 73 of the sheet stopper 70 and the second contact part 83b of the contact portion 83 of the inversion path introduction unit 80 gradually separate. Moreover, in conjunction with the rotation of the sheet stopper 70, the second contact part 73b of the contact portion 73 of the sheet stopper 70 and the second contact part 83b of the contact portion 83 of the inversion path introduction unit 80 gradually make contact. By this, the contact area 103 gradually changes from a state where the first contact part 73a of the contact portion 73 of the sheet stopper 70 and the second contact part 83b of the contact portion 83 of the inversion path introduction unit 80 are making contact to a state where the second contact part 73b of the contact portion 73 of the sheet stopper 70 and the second contact part 83b of the contact portion 83 of the inversion path introduction unit 80 are making contact.

Then, when the inversion path introduction unit 80 is rotated further from the state illustrated in FIG. 7B, the second contact part 73b of the sheet stopper 70 is pushed by the second contact part 83b of the inversion path introduction unit 80. As a result, the sheet stopper 70 is further rotated toward the regulating position. Then, as illustrated in FIG. 7C, in conjunction with the rotation of the sheet stopper 70, the second contact part 73b of the contact portion 73 of the sheet stopper 70 and the second contact part 83b of the contact portion 83 of the inversion path introduction unit 80 gradually separate. Moreover, in conjunction with the rotation of the sheet stopper 70, the second contact part 73b of the contact portion 73 of the sheet stopper 70 and the first contact part 83a of the contact portion 83 of the inversion path introduction unit 80 gradually make contact. By this, the contact area 103 gradually changes from the state where the second contact part 73b of the contact portion 73 of the sheet stopper 70 and the second contact part 83b of the contact portion 83 of the inversion path introduction unit 80 are making contact to a state where the second contact part 73b of the contact portion 73 of the sheet stopper 70 and the first contact part 83a of the contact portion 83 of the inversion path introduction unit 80 are making contact.

Then, when the inversion path introduction unit 80 is further rotated from the state illustrated in FIG. 7C, the second contact part 73b of the sheet stopper 70 is pushed by the first contact part 83a of the inversion path introduction unit 80. As a result, the sheet stopper 70 is further rotated toward the regulating position. Then, in conjunction with the rotation of the sheet stopper 70, the second contact part 73b of the contact portion 73 of the sheet stopper 70 and the first contact part 83a of the contact portion 83 of the inversion path introduction unit 80 gradually separate. Moreover, in conjunction with the rotation of the sheet stopper 70, the first contact part 73a of the contact portion 73 of the sheet stopper 70 and the first contact part 83a of the contact portion 83 of the inversion path introduction unit 80 gradually make contact. By this, the contact area 103 gradually changes from the state where the second contact part 73b of the contact portion 73 of the sheet stopper 70 and the first contact part 83a of the contact portion 83 of the inversion path introduction unit 80 are making contact to a state where the first contact part 73a of the contact portion 73 of the sheet stopper 70 and the first contact part 83a of the contact portion 83 of the inversion path introduction unit 80 are making contact.

Then, as illustrated in FIG. 7D, a state is entered into where the sheet stopper 70 is in the regulating position and the inversion path introduction unit 80 is in the reverse-feeding position. In this state, the contact area 103 is formed by the first contact part 73a of the sheet stopper 70 and the first contact part 83a of the inversion path introduction unit 80 making surface contact.

As above, in the printing device 100, by a rotational force being transferred from the inversion path introduction unit 80 to the sheet stopper 70 while changing the contact area 103, the sheet stopper 70 is rotated in conjunction with the rotation of the inversion path introduction unit 80.

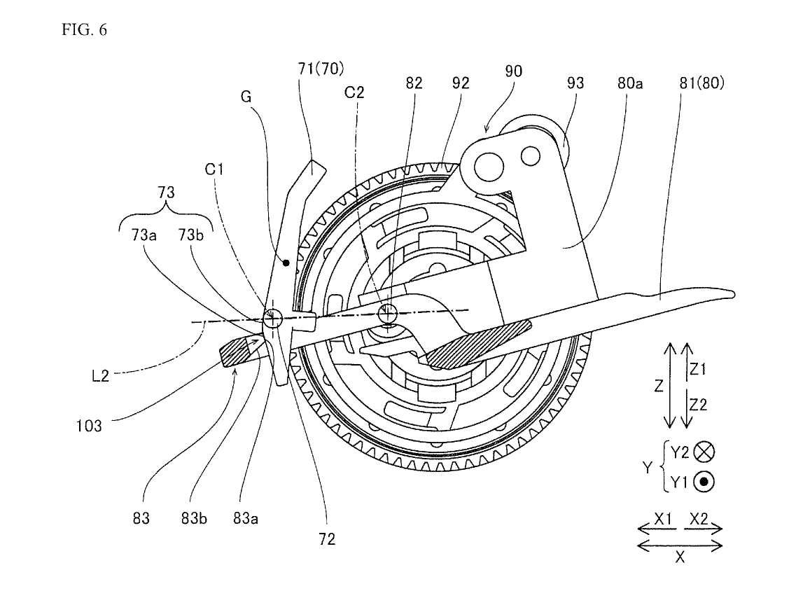

As illustrated in FIGS. 5 and 6, in the printer 100 of the first embodiment of the present invention, the drive force generated by the motor 91 of the drive mechanism unit 90 is transferred to the inversion path introduction unit 80 via the gear 92 and the arm portion 93. By this, the drive force of the motor 91 transferred to the inversion path introduction unit 80 is transferred to the sheet stopper 70 via the contact area 103. As a result, the sheet stopper 70 is rotated together with the inversion path introduction unit 80 in accordance with the inversion path introduction unit 80 being rotated by the drive mechanism unit 90.

As illustrated in FIGS. 5 and 8, in the first embodiment of the present invention, in a situation where the inversion path introduction unit 80 enters the forward-feeding position, the sheet stopper 70 enters the passing position in conjunction therewith. Moreover, as illustrated in FIG. 6, in a situation where the inversion path introduction unit 80 enters the reverse-feeding position, the sheet stopper 70 enters the regulating position in conjunction therewith.

As illustrated in FIG. 5, in the passing position of the sheet stopper 70, the second contact part 83b of the contact portion 83 of the inversion path introduction unit 80 is disposed on an upper side of the first contact part 73a of the contact portion 73 of the sheet stopper 70, opposing the first contact part 73a of the contact portion 73 of the sheet stopper 70. Moreover, in the passing position of the sheet stopper, the second contact part 83b of the contact portion 83 of the inversion path introduction unit 80 is configured to contact the first contact part 73a of the contact portion 73 of the sheet stopper 70 from an upper side (Z1 side). Moreover, in the first embodiment of the present invention, in the passing position of the sheet stopper 70, the contact area 103 is positioned above a line L1 passing through a rotation center C1 of the sheet stopper 70 and a rotation center C2 of the inversion path introduction unit 80.

Furthermore, as illustrated in FIGS. 1 to 3, the printer 100 includes a sheet loading surface 104 that contacts a lower end of the sheet 101 placed in the feeding tray 20. As illustrated in FIGS. 1 and 2, in the passing position, the sheet stopper 70 is disposed below the sheet loading surface 104.

As illustrated in FIG. 6, in the regulating position of the sheet stopper 70, the first contact part 83a of the contact portion 83 of the inversion path introduction unit 80 is disposed on an upstream side (X1 side, lateral side) in the sheet feeding direction, opposing the first contact part 73a of the contact portion 73 of the stopper 70. Moreover, in the regulating position of the sheet stopper 70, the first contact part 83a of the contact portion 83 of the inversion path introduction unit 80 is configured to contact the first contact part 73a of the contact portion 73 of the sheet stopper 70 from the upstream side (X1 side, lateral side) in the sheet feeding direction. Moreover, in the first embodiment of the present invention, in the regulating position of the sheet stopper 70, the contact area 103 is positioned below (Z2 direction) a line L2 passing through the rotation center C1 of the sheet stopper 70 and the rotation center C2 of the inversion path introduction unit 80. Moreover, in the regulating position of the sheet stopper 70, the first contact part 83a of the contact portion 83 of the inversion path introduction unit 80 is configured to support the sheet stopper 70 from the lateral side by contacting the first contact part 73a of the contact portion 73 of the sheet stopper 70 from the upstream side (X1 side, lateral side) in the sheet feeding direction.

Furthermore, as illustrated in FIG. 9, in the first embodiment of the present invention, in the regulating position, the sheet stopper 70 is disposed on a downstream side (X2 side), in the sheet feeding direction, of a position of the sheet 101 when a maximum amount of the sheet is loaded in the feeding tray 20. Specifically, in the regulating position, the sheet stopper 70 is disposed in a position separated by a distance D in the sheet feeding direction (X direction) from the position of the sheet 101 when the maximum amount of the sheet is loaded in the feeding tray 20.

Furthermore, as illustrated in FIGS. 5 and 6, in the first embodiment of the present invention, in the regulating position, the sheet stopper 70 is configured to enter the passing position by rotating toward the downstream side (X2 side) in the sheet feeding direction. Moreover, in the regulating position, the sheet stopper 70 is configured so a center of gravity G is positioned on a downstream side, in the sheet feeding direction, of the rotation center C1 of the sheet stopper 70. By this, in the printer 100, in a situation where a state of the sheet stopper 70 being supported by the first contact part 83a of the contact portion 83 of the inversion path introduction unit 80 ends, the passing position can be entered into by the sheet stopper 70 rotating toward the downstream side in the sheet feeding direction by a bias of the center of gravity.

Furthermore, as illustrated in FIG. 7D, in the first embodiment of the present invention, a rotation angle θ1 between the reverse-feeding position and the forward-feeding position of the inversion path introduction unit 80 is less than a rotation angle θ2 between the regulating position and the passing position of the sheet stopper 70. That is, the rotation angle θ1 between the reverse-feeding position and the forward-feeding position of the inversion path introduction unit 80 and the rotation angle θ2 between the regulating position and the passing position of the sheet stopper 70 are not 1:1.

Specifically, the rotation angle θ1 between the reverse-feeding position and the forward-feeding position of the inversion path introduction unit 80 is half or less than the rotation angle θ2 between the regulating position and the passing position of the sheet stopper 70. More specifically, the rotation angle θ1 between the reverse-feeding position and the forward-feeding position of the inversion path introduction unit 80 is one-third or less than the rotation angle θ2 between the regulating position and the passing position of the sheet stopper 70. Because it is sufficient for the inversion path introduction unit 80 to rotate only by an extent where one sheet 101 can be introduced, no inconvenience arises even if the rotation angle is small compared to the sheet stopper 70, which needs to stop the sheet 101. Moreover, according to one or more embodiments of the present invention, the rotation angle θ1 of the inversion path introduction unit 80 is small from a viewpoint of suppressing the printer 100 from increasing in size in the vertical direction. The rotation angle θ1 between the reverse-feeding position and the forward-feeding position of the inversion path introduction unit 80 is, for example, about 15 degrees. Moreover, the rotation angle θ2 between the regulating position and the passing position of the sheet stopper 70 is, for example, about 75 degrees.

Furthermore, as illustrated in FIGS. 3 and 4, in the first embodiment of the present invention, a bearing unit 105 is provided in the printer 100. The bearing unit 105 is provided to each sheet stopper 70. In the printer 100, the bearing unit 105 is configured to rotatably hold the rotation shaft 82 of the inversion path introduction unit 80 and the rotation shaft 72 of the sheet stopper 70. The rotation shaft 82 of the inversion path introduction unit 80 is provided in a vicinity of the rotation shaft 72 of the sheet stopper 70.

By this, in a situation where, in the regulating position of the sheet stopper 70, a force due to the sheet 101 being pushed in (force heading substantially in an X2 direction) acts on the sheet stopper 70, it becomes possible to flexurally deform in substantially the X1 direction not an entirety of the inversion path introduction unit 80 but a portion between the rotation shaft 82 and the contact portion 83 of the inversion path introduction unit 80. In a situation where the portion between the rotation shaft 82 to the contact portion 83 of the inversion path introduction unit 80 flexurally deforms, an overall flexure amount of the inversion path introduction unit 80 decreases; therefore, a large proportion of the rotational force due to the sheet stopper 70 can be received by the contact portion 83 of the inversion path introduction unit 80. As a result, in a situation where the force due to the sheet 101 being pushed in acts excessively on the sheet stopper 70, the force transferred from the sheet stopper 70 to the contact portion 83 of the inversion path introduction unit 80 increases; therefore, a force of rotating the inversion path introduction unit 80 from the reverse-feeding position to the forward-feeding position increases. Therefore, it becomes possible to stably rotate the inversion path introduction unit 80 from the reverse-feeding position to the forward-feeding position in conjunction with the sheet stopper 70 rotating from the regulating position to the passing position.

Furthermore, as illustrated in FIG. 3, in the first embodiment of the present invention, the gear 92 of the drive mechanism unit 90 is connected to the feeding roller 30 in addition to the inversion path introduction unit 80. By this, the motor 91 of the drive mechanism unit 90 is configured to rotate the feeding roller 30.

(Duplex Printing Operation)

Next, a duplex printing operation by the printer 100 according to the first embodiment of the present invention is described with reference to FIGS. 8 and 9.

As illustrated in FIG. 8, the sheet 101 placed in the feeding tray 20 by the feeding roller 30 is fed in a state where the sheet stopper 70 is in the passing position and the inversion path introduction unit 80 is in the forward-feeding position. Then, the sheet 101 is conveyed along the sheet feeding path 102 by the conveyance roller 40 and printing on a surface of the sheet 101 is performed by the printhead 10. In a situation of simplex printing, after the printing by the printhead 10 on the surface of the sheet 101, the simplex-printed sheet 101 is discharged from the discharge port 100b.

In a situation of duplex printing, after the printing by the printhead 10 on the surface of the sheet 101, the conveyance roller 40 rotates in reverse. Then, as illustrated in FIG. 9, the sheet 101 is conveyed to the inversion path 61 formed by the inversion path unit 60 in a state where the sheet stopper 70 is in the regulating position and the inversion path introduction unit 80 is in the reverse-feeding position. As a result, the sheet 101 is inverted from a state where the surface of the sheet 101 is the upper surface to a state where a reverse surface of the sheet 101 is the upper surface. Afterward, the sheet 101 whose reverse surface is become the upper surface is conveyed to a position below the printhead 10. Then, printing by the printhead 10 on the reverse surface of the sheet 101 is performed. As a result, duplex printing on the sheet 101 is performed in the printer 100. Then, after printing on both surfaces—the surface and the reverse surface—of the sheet 101, the duplex-printed sheet 101 is discharged from the discharge port 100b.

### Effects of the First Embodiment

In the first embodiment of the present invention, one or more of the following effects may be obtained.

As above, in the first embodiment of the present invention, the sheet stopper 70 and the inversion path introduction unit 80 are configured to be interlocked. By this, the sheet stopper 70, which is a stopper mechanism, and the inversion path introduction unit 80, which is a duplex-printing mechanism, can share a drive mechanism; therefore, even if a stopper mechanism is provided, there is no need to provide a drive mechanism dedicated to the stopper mechanism. As a result, a space required to dispose both the stopper mechanism and the duplex-printing mechanism inside the printer 100 can be decreased; therefore, the stopper mechanism can be provided while suppressing a size increase of the device.

Furthermore, as above, in the first embodiment of the present invention, the contact portion 73 of the sheet stopper 70 and the contact portion 83 of the inversion path introduction unit 80 contact each other at the contact area 103 for interlocking. By this, a component count can be further decreased compared to a situation where dedicated members are provided to interlock the sheet stopper 70 and the inversion path introduction unit 80. As a result, the sheet stopper 70 and the inversion path introduction unit 80 can be rotated in conjunction with a simpler mechanism.

Furthermore, as above, in the first embodiment of the present invention, in the regulating position of the sheet stopper 70, the contact portion 83 of the inversion path introduction unit 80 is configured to support the sheet stopper 70. By this, the sheet stopper 70 is supported by the contact portion 83 of the inversion path introduction unit 80 even in a situation where the sheet 101 is pushed in by a user; therefore, the sheet stopper 70 can be suppressed from moving due to a force of the sheet 101 being pushed in. As a result, the sheet 101 can be reliably stopped by the sheet stopper 70.

Furthermore, as above, in the first embodiment of the present invention, in the regulating position of the sheet stopper 70, the contact area 103 is positioned below the line L2 passing through the rotation center C1 of the sheet stopper 70 and the rotation center C2 of the inversion path introduction unit 80. By this, a force in a direction of rotating from the regulating position to the passing position of the sheet stopper 70 can be made to be received more readily by the inversion path introduction unit 80 in a situation where the sheet stopper 70 is supported from the side by the inversion path introduction unit 80. As a result, the force whereby the inversion path introduction unit 80 supports the sheet stopper 70 can be increased; therefore, the sheet 101 can be more reliably stopped by the sheet stopper 70 even in the situation where the sheet 101 is pushed in by the user.

Moreover, as above, in the first embodiment of the present invention, in the passing position of the sheet stopper 70, the contact area 103 is positioned above the line L1 passing through the rotation center C1 of the sheet stopper 70 and the rotation center C2 of the inversion path introduction unit 80. By this, a force in a direction of rotating from the passing position to the regulating position of the sheet stopper 70 can be imparted more readily from the inversion path introduction unit 80 to the sheet stopper 70 in a situation where the sheet stopper 70 is rotated by the inversion path introduction unit 80. As a result, the sheet stopper 70 can be readily rotated by the inversion path introduction unit 80.

Furthermore, as above, in the first embodiment of the present invention, the rotation shaft 82 of the inversion path introduction unit 80 is provided in the vicinity of the rotation shaft 72 of the sheet stopper 70. By this, stress can be readily concentrated in an area between the rotation shaft 82 of the inversion path introduction unit 80 and the contact portion 83; therefore, a force can be transferred more readily from the sheet stopper 70 to the contact portion 83 of the inversion path introduction unit 80 compared to a situation where the stress is dispersed over an entirety of the inversion path introduction unit 80. As a result, the contact portion 83 of the inversion path introduction unit 80 can more readily receive the force of the sheet being pushed in acting on the sheet stopper 70; therefore, the force whereby the inversion path introduction unit 80 supports the sheet stopper 70 can be further increased. Therefore, the sheet 101 can be even further reliably stopped by the sheet stopper 70 even in the situation where the sheet 101 is pushed in by the user. Moreover, in a situation where the force of the sheet 101 being pushed in acts excessively on the sheet stopper 70, it becomes possible to stably rotate the inversion path introduction unit 80 from the reverse-feeding position to the forward-feeding position in conjunction with the sheet stopper 70 rotating from the regulating position to the passing position.

Furthermore, as above, in the first embodiment of the present invention, the bearing unit 105 that holds the rotation shaft 82 of the inversion path introduction unit 80 and the rotation shaft 72 of the sheet stopper 70 is provided. By this, the rotation shaft 82 of the inversion path introduction unit 80 and the rotation shaft 72 of the sheet stopper 70 can be held by the same bearing unit 105; therefore, the component count can be decreased even further. Moreover, by holding the rotation shaft 82 of the inversion path introduction unit 80 and the rotation shaft 72 of the sheet stopper 70 by the same bearing unit 105, the rotation shaft 82 of the inversion path introduction unit 80 can be readily provided in the vicinity of the rotation shaft 72 of the sheet stopper 70.

Furthermore, as above, in the first embodiment of the present invention, the contact portion 73 of the sheet stopper 70 is formed so as to be bent. By this, the sheet stopper 70 and the inversion path introduction unit 80 can be rotated along the bent contact portion 73 of the sheet stopper 70; therefore, the sheet stopper 70 and inversion path introduction unit 80 can be smoothly rotated in conjunction.

Furthermore, as above, in the first embodiment of the present invention, in the regulating position, the sheet stopper 70 is configured to rotate toward the downstream side in the sheet feeding direction. By this, unlike a situation where in the regulating position the sheet stopper 70 rotates toward an upstream side in the sheet feeding direction, the sheet stopper 70 can be rotated from the regulating position to the passing position without being blocked by the sheet 101.

Furthermore, as above, in the first embodiment of the present invention, in the regulating position, the sheet stopper 70 is configured so the center of gravity G is positioned on the downstream side, in the sheet feeding direction, of the rotation center C1 of the sheet stopper 70. By this, a weight of the sheet stopper 70 itself can be utilized to readily rotate the sheet stopper 70 toward the downstream side in the sheet feeding direction.

Furthermore, as above, in the first embodiment of the present invention, in the regulating position, the sheet stopper 70 is disposed on the downstream side, in the sheet feeding direction, of the position of the sheet when the maximum amount of the sheet is loaded in the feeding tray. By this, the sheet 101 can be stopped by the sheet stopper 70 by placing the sheet stopper 70 in the regulating position even when the maximum amount of the sheet is loaded.

Furthermore, as above, in the first embodiment of the present invention, in the passing position, the sheet stopper 70 is disposed below the sheet loading surface 104. By this, in the passing position, the sheet stopper 70 can be suppressed from impeding conveyance of the sheet 101, which passes through the sheet loading surface 104.

Furthermore, as above, in the first embodiment of the present invention, the rotation angle θ1 between the reverse-feeding position and the forward-feeding position of the inversion path introduction unit 80 is less than the rotation angle θ2 between the regulating position and the passing position of the sheet stopper 70. By this, the rotation angle of the inversion path introduction unit 80 decreases; therefore, the inversion path introduction unit 80 can be suppressed from rotating excessively (standing up).

Furthermore, as above, in the first embodiment of the present invention, the rotation angle θ1 between the reverse-feeding position and the forward-feeding position of the inversion path introduction unit 80 is half or less than the rotation angle θ2 between the regulating position and the passing position of the sheet stopper 70. By this, the rotation angle of the inversion path introduction unit 80 further decreases; therefore, the inversion path introduction unit 80 can be further suppressed from rotating excessively (standing up).

Furthermore, as above, in the first embodiment of the present invention, the rotation angle θ1 between the reverse-feeding position and the forward-feeding position of the inversion path introduction unit 80 is one-third or less than the rotation angle θ2 between the regulating position and the passing position of the sheet stopper 70. By this, the rotation angle of the inversion path introduction unit 80 decreases even further; therefore, the inversion path introduction unit 80 can be suppressed even further from rotating excessively (standing up).

Furthermore, as above, in the first embodiment of the present invention, the printer 100 is configured so the sheet stopper 70 rotates in accordance with the rotation of the inversion path introduction unit 80. By this, in a situation where the inversion path introduction unit 80 is larger than the sheet stopper 70, the sheet stopper 70, which is a small member, can be rotated in conjunction with the rotation of the inversion path introduction unit 80, which is a large member; therefore, the sheet stopper 70 and the inversion path introduction unit 80 can be readily rotated in conjunction.

Furthermore, as above, in the first embodiment of the present invention, the drive mechanism unit 90 includes the motor 91, the gear 92 that is rotated by the motor 91, and the arm portion 93 that connects the gear 92 and the inversion path introduction unit 80. By this, a drive force generated by the motor 91 can be transferred to the inversion path introduction unit 80 via the gear 92 and the arm portion 93 to rotate the inversion path introduction unit 80 and the sheet stopper 70.

Furthermore, as above, in the first embodiment of the present invention, the motor 91 of the drive mechanism unit 90 is configured to rotate the feeding roller 30. By this, the sheet stopper 70, the inversion path introduction unit 80, and the feeding roller 30 can be moved by the same power source (the motor 91 of the drive mechanism unit 90); therefore, the component count can be decreased compared to a situation where a power source for the feeding roller 30 is provided separately.

### Second Embodiment

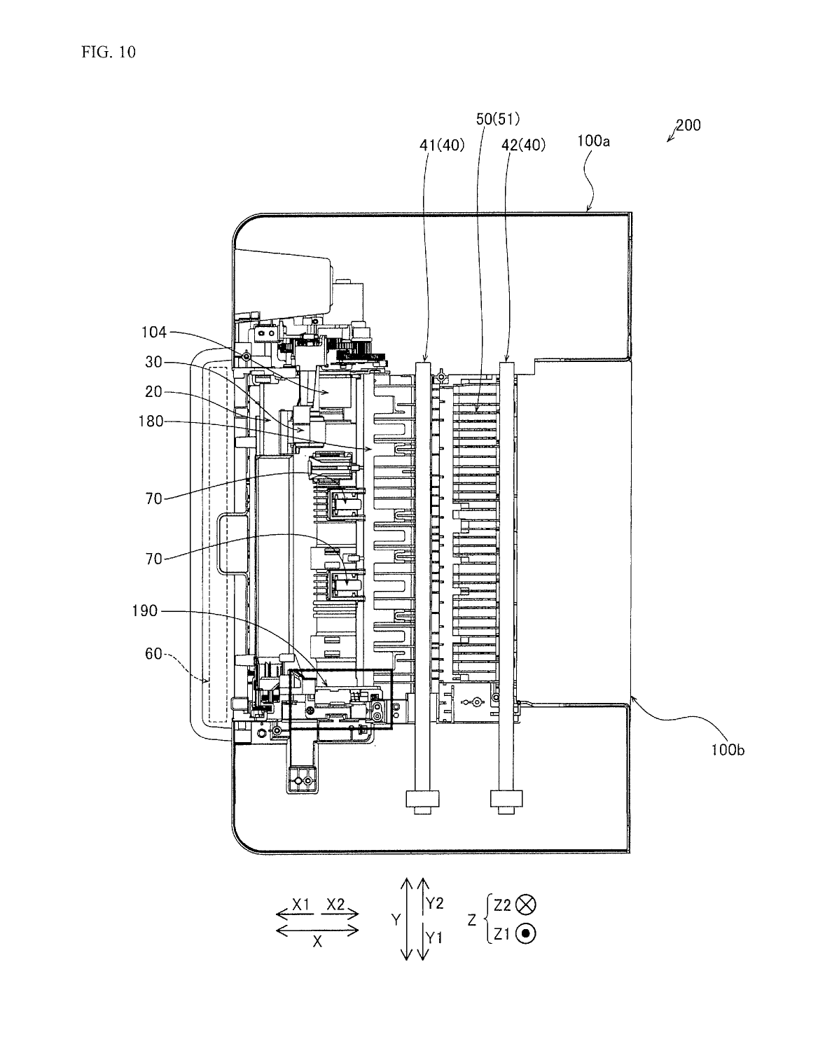

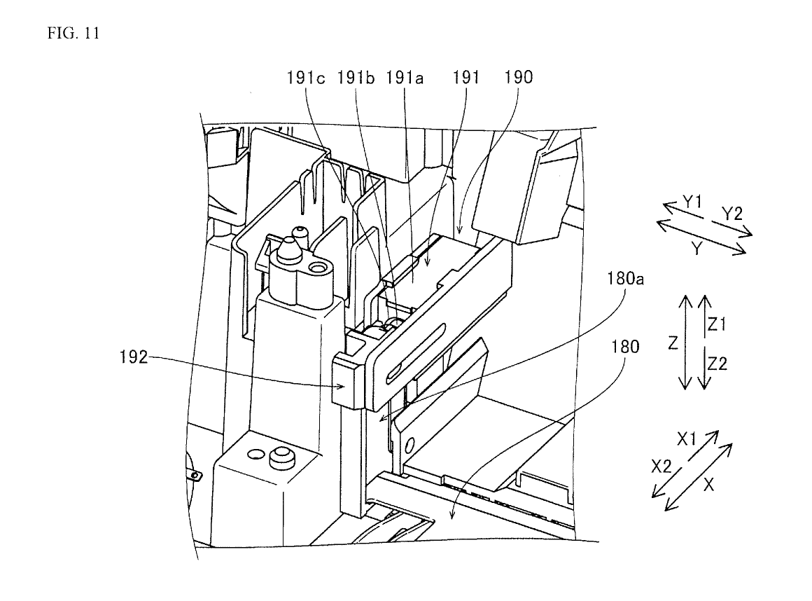

Next, a second embodiment of the present invention is described with reference to FIGS. 10 to 14. In the second embodiment of the present invention, an example is described where unlike the first embodiment of the present invention a drive mechanism unit includes a solenoid. Configurations similar to the first embodiment of the present invention are illustrated labeled with the same reference numerals in the drawings and description thereof is omitted.

(Configuration of Printer)

As illustrated in FIG. 10, a printer 200 according to the second embodiment of the present invention includes an inversion path introduction unit 180 and a drive mechanism unit 190. The drive mechanism unit 190 is provided on a Y1 side of the inversion path introduction unit 180 and is configured to rotate the inversion path introduction unit 180.

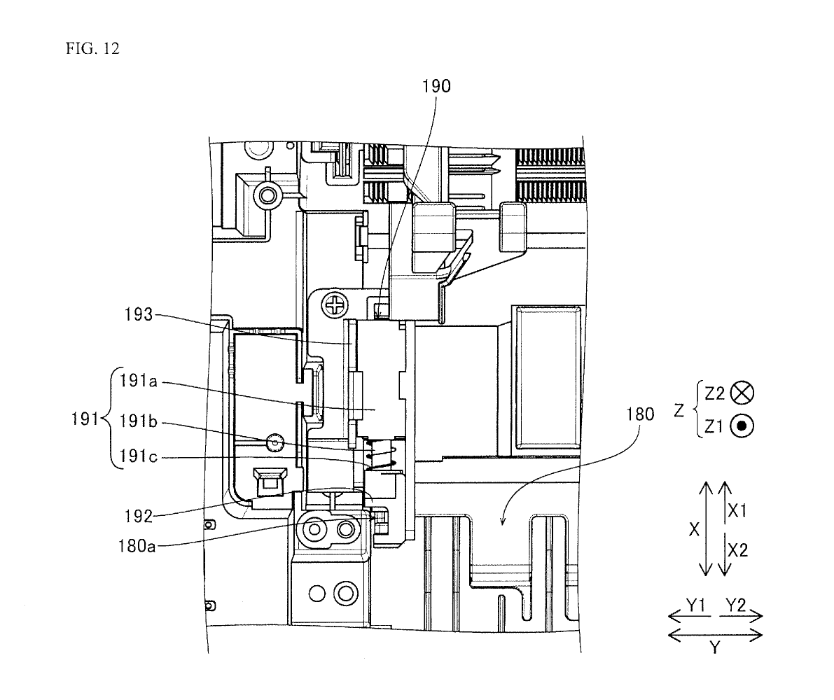

As illustrated in FIGS. 11 and 12, the drive mechanism unit 190 includes a solenoid 191 and a solenoid connecting unit 192. The solenoid 191 is configured to generate a drive force for driving the inversion path introduction unit 180. The solenoid 191 has a main body portion 191a, a movable iron core 191b, and a return spring 191c.

The solenoid 191 is configured so in a state where a current is flowing in the main body portion 191a the movable iron core 191b is pulled into the main body portion 191a and moves in the X1 direction. Moreover, the solenoid 191 is configured so in a state where no current is flowing in the main body portion 191a the movable iron core 191b returns to a home position (position in the state where no current is flowing in the main body portion 191a) by a biasing force of the return spring 191c. In the printer 100, the solenoid 191 is fixed in the housing 100a by a solenoid fixing member 193.

The solenoid connecting portion 192 is configured to connect the movable iron core 191b of the solenoid 191 and a sidewall portion 180a of the inversion path introduction unit 180. Moreover, the solenoid connecting portion 192 is installed to a tip of the movable iron core 191b and is configured to move according to the movement of the movable iron core 191b.

In the printer 200 of the second embodiment of the present invention, the drive force generated by the solenoid 191 of the drive mechanism unit 190 is transferred to the inversion path introduction unit 180 via the solenoid connecting portion 192. As a result, the inversion path introduction unit 180 and the sheet stopper 70 are rotated in accordance with the movable iron core 191b of the solenoid 191 moving.

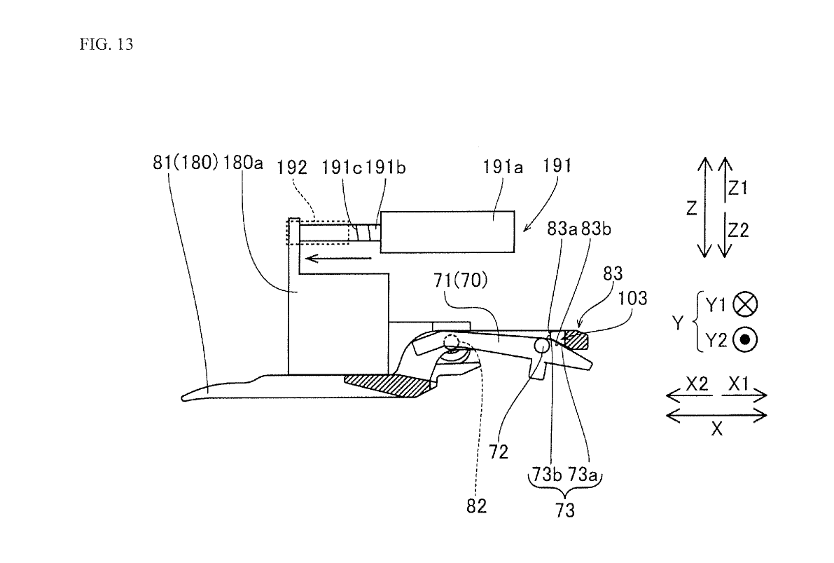

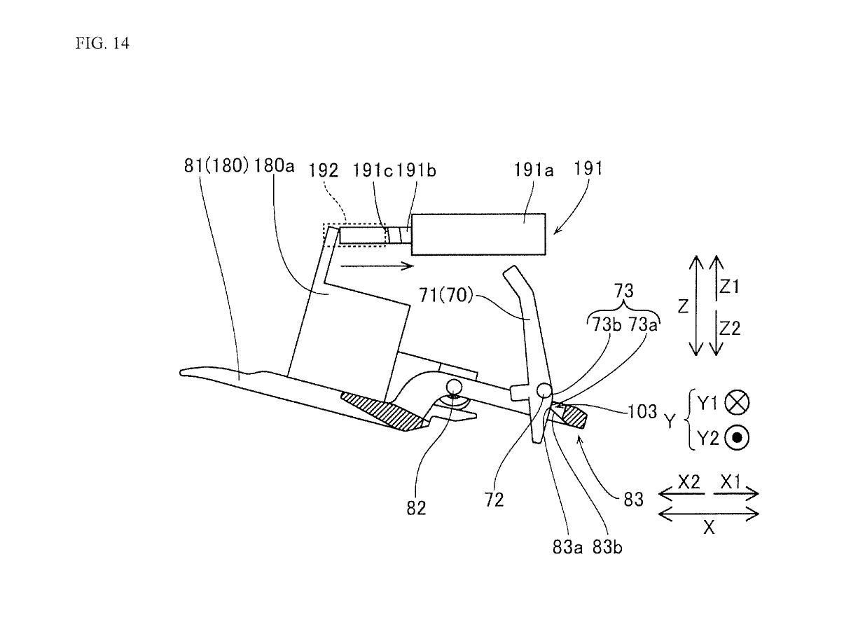

Specifically, as illustrated in FIG. 13, in a situation where the movable iron core 191b of the solenoid 191 moves in the X2 direction toward the home position from the state of being pulled into the main body portion 191a, the sheet stopper 70 and the inversion path introduction unit 180 rotate such that the sheet stopper 70 enters the passing position and the inversion path introduction unit 180 enters the forward-feeding position. Moreover, as illustrated in FIG. 14, in a situation where the movable iron core 191b of the solenoid 191 is pulled into the main body portion 191a from the home position and moves in the X1 direction, the sheet stopper 70 and the inversion path introduction unit 180 rotate such that the sheet stopper 70 enters the regulating position and the inversion path introduction unit 180 enters the reverse-feeding position.

Note that other configurations of the second embodiment of the present invention are similar to the first embodiment of the present invention.

### Effects of the Second Embodiment

In the second embodiments of the present invention, one or more of the following effects may be obtained.

As above, in the second embodiment of the present invention, the drive mechanism unit 190 includes the solenoid 191 that generates the drive force and the solenoid connecting portion 192 that connects the solenoid 191 and the inversion path introduction unit 180. By this, the drive force generated by the solenoid 191 can be transferred to the inversion path introduction unit 180 via the solenoid connecting portion 192 to rotate the inversion path introduction unit 180 and the sheet stopper 70.

The second embodiment of the present invention may have effects similar to the first embodiment of the present invention.

### Modified Examples

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in the first and second embodiments of the present invention, an example is illustrated where the sheet stopper and the inversion path introduction unit have contact portions for interlocking, but one or more embodiments of the present invention is not limited thereto. In one or more embodiments of the present invention, the sheet stopper and the inversion path introduction unit do not have to have contact portions for interlocking. In this situation, a member for interlocking the sheet stopper and the inversion path introduction unit may be provided between the sheet stopper and the inversion path introduction unit.

Furthermore, in the first and second embodiments of the present invention, an example is illustrated where, in the regulating position of the sheet stopper, the contact area of the sheet stopper and the inversion path introduction unit is positioned below the line passing through the rotation center of the sheet stopper and the rotation center of the inversion path introduction unit, but the present invention is not limited thereto. In one or more embodiments of the present invention, in the regulating position of the sheet stopper, the contact area of the sheet stopper and the inversion path introduction unit may be positioned above the line passing through the rotation center of the sheet stopper and the rotation center of the inversion path introduction unit.

Furthermore, in the first and second embodiments of the present invention, an example is illustrated where, in the passing position of the sheet stopper, the contact area of the sheet stopper and the inversion path introduction unit is positioned above the line passing through the rotation center of the sheet stopper and the rotation center of the inversion path introduction unit, but one or more embodiments of the present invention is not limited thereto. In one or more embodiments of the present invention, in the passing position of the sheet stopper, the contact area of the sheets stopper and the inversion path introduction unit may be positioned below the line passing through the rotation center of the sheet stopper and the rotation center of the inversion path introduction unit.

Furthermore, in the first and second embodiments of the present invention, an example is illustrated where the rotation shaft of the inversion path introduction unit is provided in the vicinity of the rotation shaft of the sheet stopper, but one or more embodiments of the present invention is not limited thereto. In one or more embodiments of the present invention, the rotation shaft of the inversion path introduction unit does not have to be provided in the vicinity of the rotation shaft of the sheet stopper.

Furthermore, in the first and second embodiments of the present invention, an example is illustrated where the printer includes a bearing unit that holds the rotation shaft of the inversion path introduction unit and the rotation shaft of the sheet stopper, but one or more embodiments of the present invention is not limited thereto. In one or more embodiments of the present invention, the printer may be individually provided with a bearing unit that holds the rotation shaft of the inversion path introduction unit and a bearing unit that holds the rotation shaft of the sheet stopper.

Furthermore, in the first and second embodiments of the present invention, an example is illustrated where the rotation angle between the reverse-feeding position and the forward-feeding position of the inversion path introduction unit is less than the rotation angle between the regulating position and the passing position of the sheet stopper, but one or more embodiments of the present invention is not limited thereto. In one or more embodiments of the present invention, the rotation angle between the reverse-feeding position and the forward-feeding position of the inversion path introduction unit and the rotation angle between the regulating position and the passing position of the sheet stopper may be the same. Moreover, the rotation angle between the reverse-feeding position and the forward-feeding position of the inversion path introduction unit may be greater than the rotation angle between the regulating position and the passing position of the sheet stopper.

Furthermore, in the first and second embodiments of the present invention, an example is illustrated where the printer includes two sheet stoppers, but one or more embodiments of the present invention is not limited thereto. In one or more embodiments of the present invention, the printer may be provided with one or three or more sheet stoppers.

Furthermore, in the first embodiment of the present invention, an example is illustrated where the drive mechanism unit includes a motor as a power source of rotating the inversion path introduction unit and the sheet stopper, and in the second embodiment of the present invention, an example is illustrated where the drive mechanism unit includes a solenoid as the power source of rotating the inversion path introduction unit and the sheet stopper, but one or more embodiments of the present invention is not limited thereto. In one or more embodiments of the present invention, a power source other than a motor or a solenoid may be used as the power source of rotating the inversion path introduction unit and the sheet stopper.

Furthermore, in the first embodiment of the present invention, an example is illustrated where the inversion path introduction unit and the feeding roller are rotated (driven) by the motor of the drive mechanism unit, but one or more embodiments of the present invention is not limited thereto. In one or more embodiments of the present invention, the conveyance roller, in addition to the inversion path introduction unit and the feeding roller, may also be rotated (driven) by the motor of the drive mechanism unit.
20 Feeding tray
30 Feeding roller
70 Sheet stopper
72 Rotation shaft (sheet-stopper side)
73 Contact portion (stopper-side contact portion)
80, 180 Inversion path introduction unit
82 Rotation shaft (inversion-path-introduction-unit side)
83 Contact portion (introduction-unit side contact portion)
90, 190 Drive mechanism unit
91 Motor
92 Gear
93 Arm portion (gear connecting portion)
100, 200 Printer
101 Sheet
103 Contact area
104 Paper loading surface
105 Bearing unit
191 Solenoid
192 Solenoid connecting portion
C1 Rotation center
C2 Rotation center
G Center of gravity
θ1 Rotation angle
θ2 Rotation angle

What is claimed is:

1. A printer comprising:
a sheet stopper that rotates between a regulating position where a sheet placed in a feeding tray is regulated and a passing position where the sheet placed in the feeding tray is passed through; and
an inversion path introduction unit that rotates between a forward-feeding position and a reverse-feeding position of introducing the sheet,
wherein the inversion path introduction unit is disposed at the forward-feeding position when a sheet is conveyed in a sheet feeding direction,
wherein the inversion path introduction unit is disposed at the reverse-feeding position when a sheet is conveyed in a direction opposite to the sheet feeding direction and the inversion path introduction unit introduces the sheet into an inversion path, and
wherein the sheet stopper changes the regulating position and the passing position in conjunction with rotation of the inversion path introduction unit.

2. The printer according to claim 1,
wherein the sheet stopper comprises a first contact portion,
wherein the inversion path introduction unit comprises a second contact portion, and
wherein the first contact portion and the second contact portion make contact and are interlocked.

3. The printer according to claim 2, wherein, when the sheet stopper is disposed at the regulating position, the second contact portion supports the sheet stopper.

4. The printer according to claim 3, wherein when the sheet stopper is disposed at the regulating position, the first contact portion and the second contact portion make contact below a line passing through a rotation center of the sheet stopper and a rotation center of the inversion path introduction unit.

5. The printer according to claim 3, wherein, when the sheet stopper is disposed at the passing position, the first contact portion and the second contact portion make contact above a line passing through a rotation center of the sheet stopper and a rotation center of the inversion path introduction unit.

6. The printer according to claim 3, wherein a rotation shaft of the inversion path introduction unit is disposed in a vicinity of a rotation shaft of the sheet stopper.

7. The printer according to claim 6, further comprising:
a bearing unit that holds the rotation shaft of the inversion path introduction unit and the rotation shaft of the sheet stopper.

8. The printer according to claim 2, wherein a shape of the first contact portion is bent.

9. The printer according to claim 1, wherein the sheet stopper rotates from the regulating position toward a downstream side in the sheet feeding direction.

10. The printer according to claim 9, wherein, when the sheet stopper is disposed at the regulating position, a center of gravity of the sheet stopper is positioned on a downstream side in the sheet feeding direction, of a rotation center of the sheet stopper.

11. The printer according to claim 1, wherein, when the sheet stopper is disposed at the regulating position, the sheet stopper is disposed on a downstream side, in the sheet feeding direction, of a sheet position when a maximum amount of the sheet is loaded in the feeding tray.

12. The printer according to claim 1, further comprising:
a sheet loading surface that contacts a lower end of the sheet placed in the feeding tray,
wherein, when the sheet stopper is disposed at the passing position, the sheet stopper is disposed below the sheet loading surface.

13. The printer according to claim 1, wherein a first rotation angle between the reverse-feeding position and the forward-feeding position of the inversion path introduction unit is less than a second rotation angle between the regulating position and the passing position of the sheet stopper.

14. The printer according to claim 13, wherein the first rotation angle is half or less than the second rotation angle.

15. The printer according to claim 14, wherein the first rotation angle is one-third or less than the second rotation angle.

16. The printer according to claim 1, further comprising:
a drive mechanism unit that rotates the inversion path introduction unit,
wherein the sheet stopper rotates in accordance with the rotation of the inversion path introduction unit.

17. The printer according to claim 16, wherein the drive mechanism unit comprises:
a motor;
a gear that is rotated by the motor; and
a gear connecting portion that connects the gear and the inversion path introduction unit.

18. The printer according to claim 17, further comprising:
a feeding roller that feeds the sheet placed in the feeding tray,
wherein the motor rotates the feeding roller.

19. The printer according to claim 16, wherein the drive mechanism unit comprises:
a solenoid that generates a drive force; and
a solenoid connecting portion that connects the solenoid and the inversion path introduction unit.

20. A printer, comprising:
a sheet stopper; and
an inversion path introduction unit interlocked with the sheet stopper,
wherein, when the sheet stopper moves to a regulating position where a sheet placed in a feeding tray is regulated, the inversion path introduction unit moves to a reverse-feeding position,
wherein the inversion path introduction unit is disposed at the reverse-feeding position when a sheet is conveyed in a direction opposite to a sheet feeding direction and the inversion path introduction unit introduces the sheet into an inversion path,
wherein, when the sheet stopper moves to a passing position where the sheet placed in the feeding tray is passed through, the inversion path introduction unit moves to a forward-feeding position, and
wherein the inversion path introduction unit is disposed at the forward-feeding position when a sheet is conveyed in the sheet feeding direction.
